(19) United States
(12) Patent Application Publication
(10) Pub. No.: US 2026/0195061 A1
(43) Pub. Date: Jul. 9, 2026

(54) MANAGING DATA IN PERSISTENT STORAGE

(71) Applicant: Dell Products L.P., Round Rock, TX (US)

(72) Inventors: Alexander Shknevsky, Fair Lawn, NJ (US); Vamsi K. Vankamamidi, Hopkinton, MA (US)

(21) Appl. No.: 19/008,855

(22) Filed: Jan. 3, 2025

(51) Int. Cl. G06F 3/06

(52) U.S. Cl. CPC G06F 3/064; G06F 3/0604; G06F 3/0659; G06F 3/067

(57) ABSTRACT

A technique is directed to managing data in persistent storage. The technique includes receiving an input/output (I/O) request specifying a write of a data block. The technique further includes storing, in a physical storage layer, (i) a physical block that contains data of the data block and (ii) size metadata that specifies a size of the physical block. The technique further includes updating a virtual block in a virtual storage layer. The updated virtual block includes location metadata that indicates a location of the physical block in the physical storage layer.

### BACKGROUND

Data storage systems are arrangements of hardware and software in which storage processors are coupled to arrays of non-volatile storage devices, such as magnetic disk drives, electronic flash drives, and/or optical drives. The storage processors, also referred to herein as “nodes,” service storage requests arriving from host machines (“hosts”), which specify blocks, files, and/or other data elements to be written, read, created, deleted, and so forth. Software running on the nodes manages incoming storage requests and performs various data processing tasks to organize and secure the data elements on the non-volatile storage devices.

Some storage systems provide virtual blocks for supporting deduplication and other block-sharing arrangements. For example, a storage system may arrange metadata that maps logical blocks to virtual blocks and metadata that maps virtual blocks to physical blocks in persistent storage. The virtual blocks may be mapped to the physical blocks by providing, within the virtual blocks, offset locations for data stored in the physical blocks and lengths of the physical blocks.

### SUMMARY

Unfortunately, storing lengths of the physical blocks within the virtual blocks may consume significant storage space in the virtual blocks. The virtual blocks are limited in size, and storing the lengths in the virtual blocks takes up space that could otherwise be used for more essential metadata. What is needed, therefore, is a way to utilize space in virtual blocks more efficiently.

The above need is addressed at least in part by an improved technique that distributes metadata between a physical storage layer and a virtual storage layer. In the physical storage layer, size metadata is stored along with physical blocks. The size metadata specifies the sizes of the physical blocks. In the virtual storage layer, virtual blocks include location metadata that points to the physical blocks. Advantageously, storing size metadata in the physical storage layer creates space for storing other, more essential metadata in the virtual storage layer, enabling the virtual storage layer to be utilized more effectively.

Certain embodiments are directed to a method of managing data in persistent storage. The method includes receiving an input/output (I/O) request specifying a write of a data block. The method further includes storing, in a physical storage layer, (i) a physical block that contains data of the data block and (ii) size metadata that specifies a size of the physical block. The method still further includes updating a virtual block in a virtual storage layer. The updated virtual block includes location metadata that indicates a location of the physical block in the physical storage layer.

Other embodiments are directed to a computerized apparatus constructed and arranged to perform a method of managing data in persistent storage, such as the method described above. Still other embodiments are directed to a computer program product. The computer program product stores instructions which, when executed on control circuitry of a computerized apparatus, cause the computerized apparatus to perform a method of managing data in persistent storage, such as the method described above.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is a block diagram of an example environment in which embodiments of the improved technique can be practiced.

FIG. 2 is a block diagram of an example data path of a data storage system of FIG. 1, according to one or more embodiments.

FIG. 3 is a block diagram showing an example read operation that accesses the data path of FIG. 2.

FIG. 4 is a block diagram showing an example decrement-to-zero operation that accesses the data path of FIG. 2.

FIG. 5 is a block diagram showing an example garbage collection operation that accesses the data path of FIG. 2.

FIG. 6 is a flowchart showing an example method of managing data in persistent storage, according to one or more embodiments.

### DETAILED DESCRIPTION

Embodiments of the improved technique will now be described. One should appreciate that such embodiments are provided by way of example to illustrate certain features and principles but are not intended to be limiting.

An improved technique is directed to distributing metadata between a physical storage layer and a virtual storage layer. In the physical storage layer, size metadata is stored along with physical blocks. The size metadata specifies the sizes of the physical blocks. In the virtual storage layer, virtual blocks include location metadata that points to the physical blocks. Advantageously, storing size metadata in the physical storage layer creates space for storing other, more essential metadata in the virtual storage layer, enabling the virtual storage layer to be utilized more effectively.

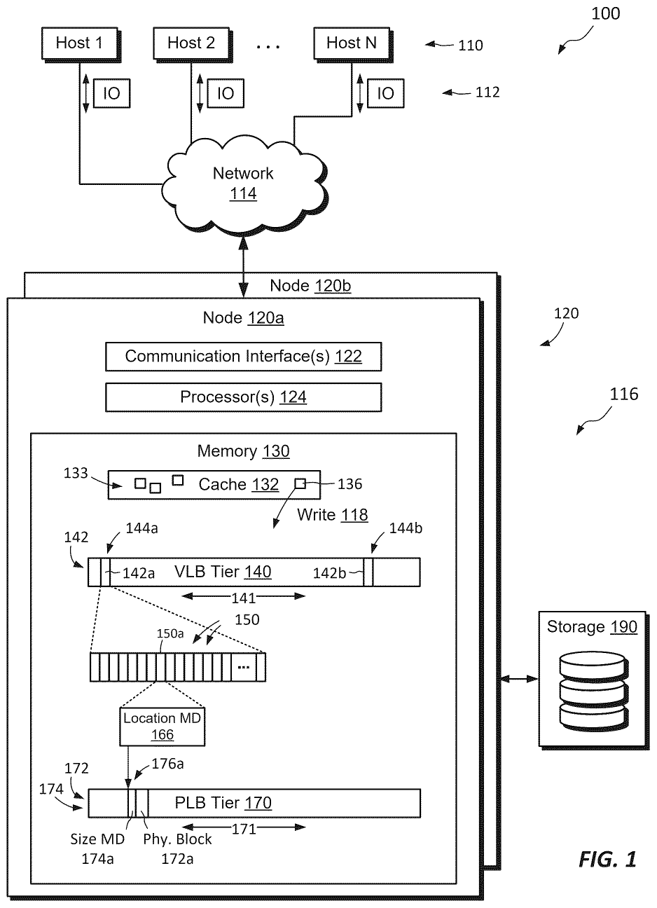

FIG. 1 shows an example environment 100 in which embodiments of the improved technique can be practiced. Here, multiple hosts 110 are configured to access a data storage system 116 over a network 114. The data storage system 116 includes one or more nodes 120 (e.g., node 120a and node 120b) and storage 190, such as magnetic disk drives, electronic flash drives, and/or the like. Nodes 120 may be provided as circuit board assemblies or blades, which plug into a chassis (not shown) that encloses and cools the nodes. The chassis has a backplane or midplane for interconnecting the nodes 120, and additional connections may be made among nodes 120 using cables. In some examples, the nodes 120 are part of a storage cluster, such as one which contains any number of storage appliances, where each appliance includes a pair of nodes 120 connected to shared storage. In some arrangements, a host application runs directly on the nodes 120, such that separate host machines 110 need not be present. No particular hardware configuration is required, however, as any number of nodes 120 may be provided, including a single node, in any arrangement, and the node or nodes 120 can be any type or types of computing device capable of running software and processing host I/O's.

The network 114 may be any type of network or combination of networks, such as a storage area network (SAN), a local area network (LAN), a wide area network (WAN), the Internet, and/or some other type of network or combination of networks, for example. In cases where hosts 110 are provided, such hosts 110 may connect to the node 120 using various technologies, such as Fibre Channel, iSCSI (Internet small computer system interface), NVMeOF (Nonvolatile Memory Express (NVMe) over Fabrics), NFS (network file system), and CIFS (common Internet file system), for example. As is known, Fibre Channel, iSCSI, and NVMeOF are block-based protocols, whereas NFS and CIFS are file-based protocols. The node 120 is configured to receive I/O requests 112 according to block-based and/or file-based protocols and to respond to such I/O requests 112 by reading or writing the storage 190.

The depiction of node 120a is intended to be representative of all nodes 120. As shown, node 120a includes one or more communication interfaces 122, a set of processors 124, and memory 130. The communication interfaces 122 include, for example, SCSI target adapters and/or network interface adapters for converting electronic and/or optical signals received over the network 114 to electronic form for use by the node 120a. The set of processors 124 includes one or more processing chips and/or assemblies, such as numerous multi-core CPUs (central processing units). The memory 130 includes both volatile memory, e.g., RAM (Random Access Memory), and non-volatile memory, such as one or more ROMs (Read-Only Memories), disk drives, solid state drives, and the like. The set of processors 124 and the memory 130 together form control circuitry, which is constructed and arranged to carry out various methods and functions as described herein. Also, the memory 130 includes a variety of software constructs realized in the form of executable instructions. When the executable instructions are run by the set of processors 124, the set of processors 124 is made to carry out the operations of the software constructs. Although certain software constructs are specifically shown and described, it is understood that the memory 130 typically includes many other software components, which are not shown, such as an operating system, various applications, processes, and daemons.

As further shown in FIG. 1, the memory 130 “includes,” i.e., realizes by execution of software instructions, a cache 132, a VLB (virtual large block) tier 140, and a PLB (physical large block) tier 170.

The cache 132 is configured to store recently-accessed data pages 133, e.g., data blocks that have been read from storage 190 and are held in cache 132 to provide fast access by applications running in the storage system 116. As shown, the cache 132 includes a particular data block 133a.

The VLB tier 140 is an in-memory representation of a tier within storage 190 that is dedicated to storing metadata pages 142, which contain virtual blocks. In an example, the VLB tier 140 is arranged as a linear array of persistent storage space, with each byte of the VLB tier 140 being addressable within an address space 141. As shown, metadata pages 142a and 142b are disposed at persistent storage locations 144a and 144b in the VLB tier 140, respectively, which may be represented as respective ranges of addresses in the address space 141.

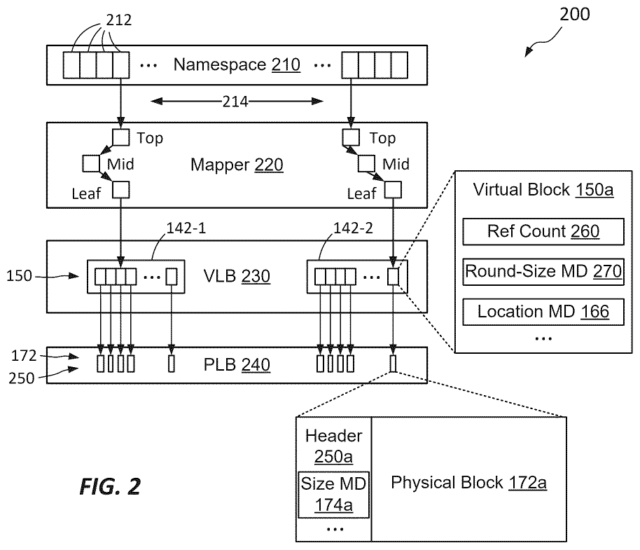

The metadata page 142a includes multiple virtual blocks 150, which may be organized in an array, for example. One such virtual block 150a includes various fields for storing metadata, such as location metadata 166 (e.g., a pointer) that indicates a location of a physical data block corresponding to the virtual block 150a in the PLB tier 170 (other example fields of a virtual block are shown in FIG. 2). The location metadata 166 typically has a fixed-length.

The PLB tier 170 is an in-memory representation of a tier within storage 190 that is dedicated to storing physical blocks 172 that contain data, such as user data received from hosts 110. According to one or more embodiments, the PLB tier 170 further stores certain metadata, such as size metadata 174, which indicates sizes of respective physical blocks. In an example, the PLB tier 170 is arranged as a linear array of persistent storage space, with each byte of the PLB tier 170 being addressable within an address space 171. As shown, a physical block 172a and its associated size metadata 174a are disposed at a first persistent storage location 176a in the PLB tier 170, e.g., in a first range of addresses in the address space 171. Although the size metadata 174a is shown as preceding the physical block 172a, the size metadata 174a may alternatively be found at a different location, such as a location that can be deterministically calculated from the location 176a.

In example operation, the data storage system 116 processes an instruction 118 to perform a write of a data block 133a to the storage 190. In response to the instruction 118, the node 120 stores the data of the data block 133a to a physical block 172, such as physical block 172a, in the PLB tier 170. Further, the node 120 stores, in the PLB tier 170, size metadata 174a that specifies a size of the physical block 172a. Further still, the node 120 updates a virtual block 150a to store location metadata 166 in the VLB tier 140, which indicates a location 176a of the physical block 172a in the PLB tier 170. For example, the location 176a may be provided as an offset within the physical address space 171. In this manner, the node services the instruction 118 to write the data of the data block to the storage 190.

Advantageously, storing the size metadata 174a in the PLB tier 170 creates space for more essential metadata in the VLB tier 140, allowing the VLB tier 140 to be utilized more effectively.

FIG. 2 shows an example data path 200 for mapping data in the storage system 116. The data path 200 provides a way of locating physical blocks in storage 190 based on logical addresses. One should appreciate that data paths may be implemented in a variety of ways and that the example shown is intended to be illustrative rather than limiting.

As shown, the data path 200 includes a namespace 210, a mapper 220, a VLB (virtual large block) layer 230, and a PLB (physical large block) layer 240. The VLB layer 230 is a representation of portions of the VLB tier 140 shown in FIG. 1. Similarly, the PLB layer 240 is a representation of portions of the PLB tier 170 shown in FIG. 1. The VLB layer 230 and the PLB layer 240 are also referred to herein as a virtual storage layer and a physical storage layer, respectively.

The namespace 210 is configured to arrange logical data blocks 212 in a large logical address space 214. Data objects such as LUNs (Logical UNits), files systems, and virtual-machine disks may be provided within respective ranges of the namespace 220. No actual user data is stored in the namespace 210, however. Rather, the namespace 220 is a logical structure that points to rather than stores user data.

The mapper 220 includes trees of mapping pointers that map logical blocks 212 in the namespace 210 to respective virtual blocks 150 in the VLB layer 230. For example, the mapper 220 includes three layers of mapping pointers, shown here as tops, mids, and leaves. The role of the mapper 220 is to provide a pointer path from each allocated logical block 212 to a respective virtual block 150.

In the VLB layer 230, virtual blocks 150 reside within metadata pages 142, with two metadata pages 142a and 142b specifically shown. For example, over 100 virtual blocks 150 may be stored within each of the metadata pages 142a and 142b.

An example virtual block 150a is shown to the right of FIG. 2. The virtual block 150a has multiple fields, such as fields for reference-count metadata 260 and the above-described location metadata 166. Additional fields may be provided in various embodiments. The reference-count metadata 260 tracks a count of references to the virtual block 150a. The location metadata 166 includes a pointer to metadata 250 contiguous with a physical block 172a in the PLB layer 240, thus associating the virtual block 150a with a physical block 172a and completing a path between a logical block 212 and a physical block 172a.

According to one or more embodiments, the virtual block 150a further stores rounded-size metadata 270. The rounded-size metadata 270 specifies a rounded size of the physical block 172 and may be produced, for example, by performing a rounding operation on the size metadata 174a. The role of the rounded-size metadata 270 will be explained in detail further below.

The PLB layer 240 includes physical blocks 172 and metadata 250 contiguous with respective ones of the physical blocks 172. The metadata 250 may be provided as a header, for example. The physical blocks 172 are typically compressed, and the headers 250 store metadata for the respective physical blocks 172. For example, the header 250a includes size metadata 174a specifying a size of the physical block 172a. In contrast to the rounded-size metadata 270, the size metadata 174a specifies a non-rounded size of the physical block 172a. In this manner, the size metadata 174a is represented using a greater number of bits than the rounded-size metadata 270. For example, the size metadata 174a may be represented using 12 or more bits, while the rounded-size metadata 270 may be represented using 3-4 bits, providing a difference of 8 or more bits.

During an example write operation, such as the one described in connection with FIG. 1, a rounding operation is performed on the size metadata 174a to generate the rounded-size metadata 270, which is stored in the virtual block 150. Further, the size metadata 174a, representing the non-rounded size of the physical block 172a, is stored in the header of the physical block 172a.

As the rounded-size metadata 270 is represented using fewer bits than the size metadata 174a, the depicted arrangement results in significant space savings in the VLB layer 230. Further, storing the rounded-size metadata 270 in the virtual block 150a enables the node 120 to identify a rough size of the physical block 242 without needing to read the size metadata 174a from the PLB layer 240.

According to some embodiments, the rounded-size metadata 270 serves additional or alternative roles. For example, if it is determined that the data stored in the physical block 174a is not compressible, the rounded-size metadata 270 may be set to a dedicated code that indicates that the data is not compressible (that is, the data is unreducible and cannot be reduced to a smaller size by compression). In some embodiments, the bits of the rounded-size metadata 270 are set all high or all low (1's or 0's) to indicate that the data is not compressible. In this manner, the rounded-size metadata 270 doubles as an indicator of whether the data is not compressible.

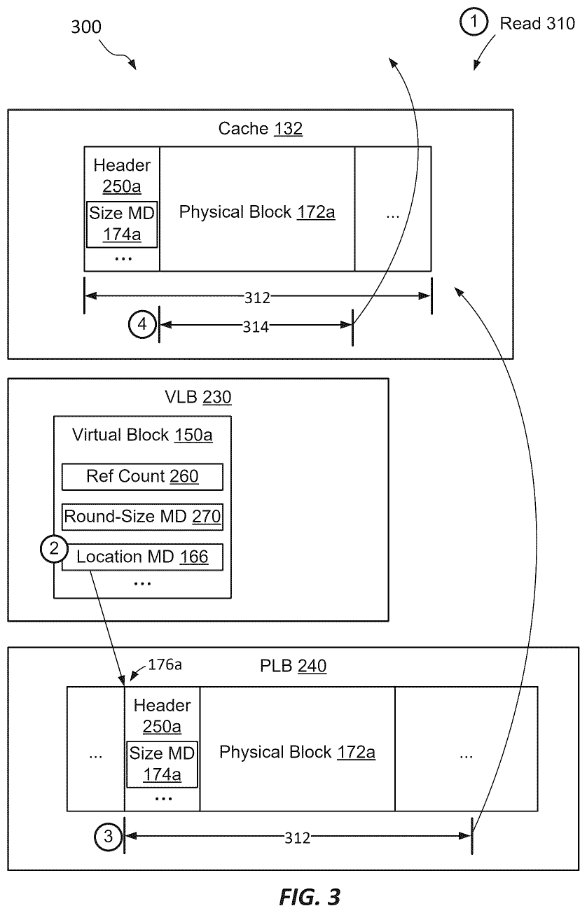

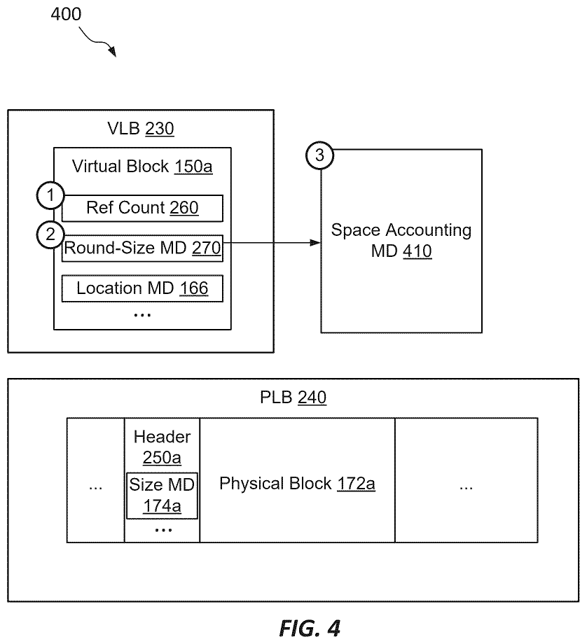

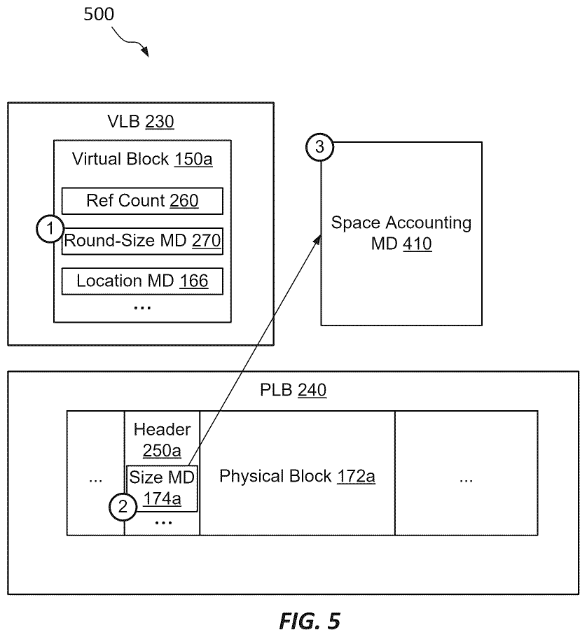

FIGS. 3-5 show a variety of example operations involving access to the VLB layer 230 and/or the PLB layer 240 shown in FIG. 2. In particular, FIG. 3 shows an example read operation 300, FIG. 4 shows an example decrement-to-zero operation 400, and FIG. 5 shows an example garbage collection operation 500. It should be appreciated that other operations may access the VLB layer 230 and/or the PLB layer 240, and the example operations shown are intended to be illustrative rather than limiting.

As shown in FIG. 3, the example read operation 300 progresses according to the encircled numbers (1)-(4). At (1), the node 120 receives a read request 310. In response, at (2), the node 120 reads the virtual block 150a to obtain location metadata 166 pointing to the location 176a of the physical block 172a, which may be the location of the header 250a associated with the physical block 172a. At (3), the node 120 reads a data extent 312 from the location 176a into the cache 132. At (4), the node 120 returns a portion 314 of the data extent to complete the read operation 300. A size of the portion 314 may be based on the size metadata 174a. For example, the node 120 may use the size metadata 174a to locate and return a portion that corresponds to the physical block 172a.

In some arrangements, the size of the data extent 312 is based on the rounded-size metadata 270. For example, the node 120 may read slightly more than the rounded size of the physical block 174a, as specified by the rounded-size metadata 270, to ensure that the entire physical block 172a is included in the read.

Alternatively, the size of the data extent 312 may be based on an uncompressed size of the data stored in the physical block 172a. For example, the data may have been provided from a data block 133 having a predetermined uncompressed size, e.g., a 4 k (4-kilobyte) or 8 k (8-kilobyte) data block. Thus, when reading data from the storage 190, the node 120 may read at least the uncompressed size to ensure that the physical block 172a is included in the read.

The size of the data extent 312 may further based on the size of the header 250a. For example, the header 250a may be a predetermined or standard size, e.g., 20 bytes. Thus, the node 120 may add the size of the header 250a when calculating the size of the data extent 312 to be read.

In arrangements in which the size of the data extent 312 is based on rounded-size metadata 270, the size of the data extent 312 may further be based on a maximum rounding error of the rounding operation used to generate the rounded-size metadata 270. This maximum rounding error is one half the place value of the least-significant bit of the rounded value. The maximum rounding error may be added to the size of the data extent 312 to ensure that the entire physical block 172a is included in the read.

Advantageously, reading a data extent 312 larger than the portion 314 that is ultimately returned ensures that the node 120 reads enough data to service the read request 300 without needing to precisely know the size of the physical block 172a in advance. Thus, the node 120 need not access the PLB layer 240 to obtain the size of the physical block 172a prior to reading the physical block 172a. As a result, the node 120 may service the read request 300 quickly and efficiently.

FIG. 4 shows an example decrement-to-zero operation 400, which progresses according to the encircled numbers (1)-(3). At (1), the decrement-to-zero operation 400 accesses the VLB layer 230 to determine whether the reference count 260 (FIG. 2) of the virtual block 150a has fallen to zero. A reference count of zero indicates that no block pointers, such as leaves in the mapper 220 (FIG. 2), point to the virtual block 150a and thus that the virtual block 150a and its associated physical block 172a can be freed. Available space in the PLB layer 240 is tracked by space-accounting metadata 410 maintained by the node 120.

When performing the decrement-to-zero operation 400, the node 120 may update the space-accounting metadata 410 to indicate an amount of available space in the PLB layer 240. Such updating is based on the rounded-size metadata 270. For example, at (2), the node 120 may access the rounded-size metadata 270 from the virtual block 150a. Further, at (3), the node 120 may subtract the rounded size of the physical block 172a from the available space. Updating space-accounting metadata 410 in this manner enables the updating to occur without needing to access the PLB layer 240 to obtain the size of the physical block 172. Thus, the updating may occur quickly and efficiently.

It should be understood that updating the space-accounting metadata 410 based on the rounded metadata 270 may cause the space-accounting metadata 410 to be slightly inaccurate. This inaccuracy is due to the difference between the rounded size of the physical block 172a and the actual size of the physical block 172a. However, such inaccuracies are negligible when taken over large numbers of physical blocks 172, as the errors tend to average to zero. Also, the inaccuracies may be corrected when the node 120 accesses the PLB layer 240, such as during a subsequent garbage collection operation 500 or the read operation 300.

FIG. 5 shows an example garbage collection operation 500, which progresses according to encircled numbers (1) and (3). The garbage collection operation 500 accesses the PLB layer 240 to reclaim storage space from the physical blocks 172 that are no longer referenced. According to one or more embodiments, the garbage collection operation 500 corrects the space-accounting metadata 410 in addition to reclaiming storage space in the PLB layer 240. For example, the garbage collection operation 500 may correct the space-accounting metadata 410 after the space-accounting metadata was updated according to the decrement-to-zero operation 400 (FIG. 4). Along these lines, at (1), the garbage collection operation 500 accesses the rounded-size metadata 270 from the virtual block 150a. Similarly, at (2), the garbage collection operation 500 accesses the size metadata 166 from the PLB layer 240. At (3), the garbage collection operation 500 takes a difference between the size metadata and the rounded-size metadata, and corrects the space-accounting metadata 410 based on the difference. In this manner, the garbage collection operation improves the accuracy of the space-accounting metadata 410.

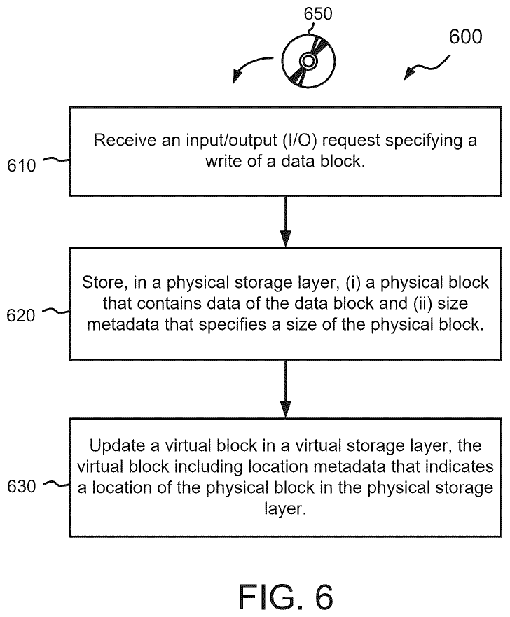

FIG. 6 shows an example method 600 that may be carried out in connection with the environment 100. The method 600 is typically performed, for example, by the software constructs described in connection with FIG. 1, which reside in the memory 130 of the node 120a and are run by the set of processors 124. The various acts of method 600 may be ordered in any suitable way. Accordingly, embodiments may be constructed in which acts are performed in orders different from that illustrated, which may include performing some acts simultaneously.

At 610, the node 120 receives an input/output (I/O) request 118 specifying a write of a data block 133a to storage 190. The data block 133a may be a standard (predetermined) size, such as a 4 k (4-kilobyte) or 8 k data block.

At 620, the node 120 stores, in the physical storage layer 240, a physical block 172a that contains data of the data block 133a, such as a compressed version of the data block 133a. In addition, the node 120 stores size metadata 174a that specifies a size of the physical block, such as the compressed size.

At 630, the node 120 updates a virtual block 150a in a virtual storage layer 230. The virtual block 230 includes location metadata 166 that indicates a location of the physical block 172a in the physical storage layer 240, such as the location of a fixed-length header 250a that immediately precedes the physical block 172a.

Having described certain embodiments, numerous alternative embodiments or variations can be made. For example, although the decrement-to-zero operation 400 was described above as updating space-accounting metadata 410 based on rounded-size metadata 270, such updating may alternatively occur based on size metadata 174 stored in the PLB layer 240.

Also, although embodiments have been described that involve one or more data storage systems, other embodiments may involve computers, including those not normally regarded as data storage systems. Such computers may include servers, such as those used in data centers and enterprises, as well as general purpose computers, personal computers, and numerous devices, such as smart phones, tablet computers, personal data assistants, and the like.

Further, although features have been shown and described with reference to particular embodiments hereof, such features may be included and hereby are included in any of the disclosed embodiments and their variants. Thus, it is understood that features disclosed in connection with any embodiment are included in any other embodiment.

Further still, the improvement or portions thereof may be embodied as a computer program product including one or more non-transient, computer-readable storage media, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like (shown by way of example as medium 650 in FIG. 6). Any number of computer-readable media may be used. The media may be encoded with instructions which, when executed on one or more computers or other processors, perform the process or processes described herein. Such media may be considered articles of manufacture or machines, and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A method of managing data in persistent storage, comprising:
receiving an input/output (I/O) request specifying a write of a data block;
storing, in a physical storage layer, (i) a physical block that contains data of the data block and (ii) size metadata that specifies a size of the physical block; and
updating a virtual block in a virtual storage layer, the virtual block including location metadata that indicates a location of the physical block in the physical storage layer.

2. The method of claim 1, further comprising, in response to receiving an I/O request specifying a read of the data block:
reading the virtual block to obtain the location metadata indicating the location of the physical block in the physical storage layer;
reading a data extent from the location indicated by the location metadata; and
returning a portion of the data extent, a size of the portion being based on the size metadata, the portion being smaller than the data extent.

3. The method of claim 2,
wherein updating the virtual block includes storing, in the virtual block, rounded-size metadata that specifies a rounded size of the physical block, and
wherein a size of the data extent is based on the rounded size of the physical block specified by the rounded-size metadata.

4. The method of claim 3,
wherein updating the virtual block further comprises performing a rounding operation to generate the rounded-size metadata, the rounding operation having a maximum rounding error, and
wherein the size of the data extent is further based on the maximum rounding error.

5. The method of claim 2,
wherein the data block has a predetermined size, and
wherein reading the data extent includes obtaining, from the location indicated by the location metadata, an amount of data greater than the predetermined size of the data block.

6. The method of claim 1, wherein storing the size metadata includes providing the size metadata in a header contiguous with the physical block.

7. The method of claim 1,
wherein storing the physical block includes compressing the data block, and
wherein the size metadata reflects a compressed size of the data block.

8. The method of claim 1, wherein updating the virtual block includes:
generating rounded-size metadata that specifies a rounded size of the physical block;
representing the rounded-size metadata using fewer bits than the size metadata; and
storing the rounded-size metadata in the virtual block.

9. The method of claim 8, wherein the rounded-size metadata has at least 8 fewer bits than the size metadata.

10. The method of claim 8, further comprising,
performing a decrement-to-zero operation that determines that no block pointers point to the virtual block; and
after performing the decrement-to-zero operation, updating space-accounting metadata that indicates an amount of available space in the physical storage layer, said updating based on the rounded-size metadata.

11. The method of claim 10, further comprising, after updating the space-accounting metadata, performing a garbage collection operation, the garbage collection operation including accessing the size metadata from the physical storage layer and correcting the space-accounting metadata to account for a difference between the size metadata and the rounded-size metadata.

12. The method of claim 6,
wherein storing the physical block includes determining that the data of the data block is not compressible, and
wherein updating the virtual block includes setting the rounded-size metadata to a dedicated code that indicates that the data of the data block is not compressible.

13. A computerized apparatus, comprising control circuitry that includes a set of processors coupled to memory, the control circuitry constructed and arranged to:
receive an input/output (I/O) request specifying a write of a data block;
store, in a physical storage layer, (i) a physical block that contains data of the data block and (ii) size metadata that specifies a size of the physical block; and
update a virtual block in a virtual storage layer, the virtual block including location metadata that indicates a location of the physical block in the physical storage layer.

14. A computer program product including a set of non-transitory, computer-readable media having instructions which, when executed by control circuitry of a computerized apparatus, cause the computerized apparatus to perform a method of managing data in persistent storage, the method comprising:
receiving an input/output (I/O) request specifying a write of a data block;
storing, in a physical storage layer, (i) a physical block that contains data of the data block and (ii) size metadata that specifies a size of the physical block; and
updating a virtual block in a virtual storage layer, the virtual block including location metadata that indicates a location of the physical block in the physical storage layer.

15. The computer program product of claim 14, wherein the method further comprises, in response to receiving an I/O request specifying a read of the data block:
reading the virtual block to obtain the location metadata indicating the location of the physical block in the physical storage layer;
reading a data extent from the location indicated by the location metadata; and
returning a portion of the data extent, a size of the portion being based on the size metadata, the portion being smaller than the data extent.

16. The computer program product of claim 15,
wherein updating the virtual block includes storing, in the virtual block, rounded-size metadata that specifies a rounded size of the physical block, and
wherein a size of the data extent is based on the rounded size of the physical block specified by the rounded-size metadata.

17. The computer program product of claim 14, wherein updating the virtual block includes:
generating rounded-size metadata that specifies a rounded size of the physical block;
representing the rounded-size metadata using fewer bits than the size metadata; and
storing the rounded-size metadata in the virtual block.

18. The computer program product of claim 17, wherein the method further comprises:
performing a decrement-to-zero operation that determines that no block pointers point to the virtual block; and
after performing the decrement-to-zero operation, updating space-accounting metadata that indicates an amount of available space in the physical storage layer, said updating based on the rounded-size metadata.

19. The computer program product of claim 18, wherein the method further comprises, after updating the space-accounting metadata, performing a garbage collection operation, the garbage collection operation including accessing the size metadata from the physical storage layer and correcting the space-accounting metadata to account for a difference between the size metadata and the rounded-size metadata.

20. The computer program product of claim 14,
wherein storing the physical block includes determining that the data of the data block is not compressible, and
wherein updating the virtual block includes setting the rounded-size metadata to a dedicated code that indicates that the data of the data block is not compressible.
